(19) United States
(12) Patent Application Publication
(10) Pub. No.: US 2010/0015027 A1
(43) Pub. Date: Jan. 21, 2010

(54) Channel-type mesoporous silica material with elliptical pore section

(75) Inventors: Chia-Min Yang, Hsinchu City (TW); Ching-Yi Lin, Hsinchu City (TW); Wei-Chia Huang, Hsinchu City (TW); Li-Lin Chang, Hsinchu City (TW)

Correspondence Address: J C PATENTS, 4 VENTURE, SUITE 250, IRVINE, CA, 92618, US

(73) Assignee: National Tsing Hua University, Hsinchu City (TW)

(21) Appl. No.: 12/456,676

(22) Filed: Jun. 19, 2009

Related U.S. Application Data
(62) Division of application No. 12/218,855, filed on Jul. 17, 2008.

(51) Int. Cl. C01B 33/26; C01B 33/12; C01B 33/20

(52) U.S. Cl. 423/328.1; 423/335; 423/326

(57) ABSTRACT

A channel-type mesoporous material with an elliptical pore section has a 2D-rectangular pore arrangement. Besides, the channel-type mesoporous material includes silica and has a unit cell ratio a/b satisfying the inequality of \sqrt{3}<a/b≦2.85. The synthesis procedure can be easily applied to prepare functional mesoporous silica materials, and examples given in this application are the syntheses of cyanoethyl-functionalized and mercaptopropyl-functionalized mesoporous materials with a c2mm symmetry. The mesoporous materials discussed herein have great potential for various advanced applications in the fields of catalysis, selective adsorption, controlled drug delivery and release, and many of other applications.

### CROSS-REFERENCE TO RELATED APPLICATION

This application is a divisional of and claims priority benefit of an application Ser. No. 12/218,855, filed on Jul. 17, 2008, now pending. The entirety of the above-mentioned patent application is hereby incorporated by reference herein and made a part of this specification.

### BACKGROUND OF THE INVENTION

1. Field of the Invention

This invention relates to a channel-type mesoporous silica material with an elliptical pore section and to a method of preparing the same.

2. Description of the Related Art

Ordered mesoporous silica materials having pore sizes between 2 nm and 50 nm were disclosed in the early 1990's, exhibiting tunable pore size, high surface area and pore volume, ease of surface functionalization and controllable morphology. Since the initial reports, considerable scientific efforts have been focused on the preparation, characterization and use of ordered mesoporous silicas. Potential applications widely include catalysis, separation, selective sorption, pollutant removal, drug delivery and release, optics, electronics, and many others.

It has become increasingly evident that any design of functional mesoporous materials requires high level of understanding of the factors governing supramolecular assembly at the mesoscale, particularly the formation and growth of hybrid inorganic-organic mesophases, and precise knowledge on the relationship between structure and properties. Detailed control of the structural and textural characteristics such as pore topology, pore diameter, and pore connectivity is desirable to reach the ultimate goals of industrial and commercial applications.

According to the pore topology, the ordered mesoporous silica materials can be classified into three categories. The first type thereof has channel-type mesopores, and the examples include MCM-41 and SBA-15 silica with 2D-hexagonal p6mm symmetry and MCM-48 and KIT-6 with Ia3d symmetry. The second type has cage-like mesopores interconnecting by narrow pore entrances, and the examples include SBA-16 with Im3m pore structure and KIT-5 with Fm3m pore structure. The third type is the layered mesoporous silica materials, which are however not useful because the layered pore structure collapses after the removal of the organic templates.

For most of the channel-type mesoporous silica materials reported in literatures, the pore section are circular because the supermolecular templating micellar structure of a surfactant is symmetrical in shape and is either spherical or rod-like. Due to the symmetrical and spherical pore geometry, the deposition of guest molecules or species into the channel-type mesopores is always equally possible at all positions inside the mesopores. For advanced applications of mesoporous silica materials, it would be highly interesting if the channel-type mesopores are somehow asymmetric and spatially defined deposition of functional groups or guest species is then possible.

### SUMMARY OF THE INVENTION

Accordingly, this invention provides a method of preparing a channel-type mesoporous material with an elliptical pore section, which allows the pore-section ellipticity and the unit cell dimensions of the mesoporous material to be tuned.

This invention further provides a channel-type mesoporous material with an elliptical pore section that is prepared with the method of this invention.

The method of preparing a channel-type mesoporous material with an elliptical pore section of this invention is described as follows. An alkaline solution containing two surfactants different in the electronic properties of their hydrophilic groups is prepared. A silica precursor is added to form a stack of rod-like micelles each having an elliptical section with the silica precursor between the rod-like micelles. The silica precursor is reacted into a silica framework. The rod-like micelles are removed from the silica framework.

In an embodiment, the above method further include selecting at least one of the combination and the molar ratio of the two surfactants so as to control the pore shape and unit cell dimensions of the channel-type mesoporous material of this invention.

The channel-type mesoporous material with an elliptical pore section of this invention has a 2D-rectangular pore arrangement, includes silica and has a unit cell ratio a/b satisfying the inequality of \sqrt{3}<a/b≦2.85.

The synthesis procedure can be easily applied to prepare functional mesoporous silica materials, and examples given in this application are the syntheses of cyanoethyl-functionalized and mercaptopropyl-functionalized mesoporous materials with a c2mm symmetry. The mesoporous materials of this invention have great potential for various advanced applications in the fields of catalysis, selective adsorption, controlled drug delivery and release, and many others.

In addition, the mesoporous material of this invention may contain one or more heteroatoms in the framework. Suitable heteroatoms include Ti and Al, and exemplary heteroatom sources include titanium isopropoxide and aluminum isopropoxide etc.

It is to be understood that both the foregoing general description and the following detailed description are exemplary, and are intended to provide further explanation of the invention as claimed.

### BRIEF DESCRIPTION OF THE DRAWINGS

FIG. 1 is a flow chart showing a method of preparing a channel-type mesoporous silica material with c2mm structure according to an embodiment of this invention.

FIG. 2 shows a unit cell (enclosed by the dash line) and the unit cell ratio a/b of a channel-type mesoporous silica material with an elliptical pore section according to this invention.

FIG. 3 shows the PXRD patterns of the c2mm mesoporous silica materials synthesized in different surfactant ratios in the example of this invention.

FIG. 4 is the transmission electron micrograph of the mesoporous silica material with c2mm structure obtained in the example of this invention, which clearly shows the elliptical pore section.

FIG. 5 shows the powder X-ray diffraction patterns of (a) the cyanoethyl-functionalized and (b) the mercaptopropyl-functionalized mesoporous materials with c2mm structure obtained in another example of this invention.

FIG. 6 shows the PXRD patterns of two c2mm mesoporous silica materials containing Ti as framework heteroatom (HUA-22-1/2, Ti in a molar percentage of 10%/5% relative to the total of Si and Ti) obtained in yet another example of this invention.

### DESCRIPTION OF THE PREFERRED EMBODIMENTS

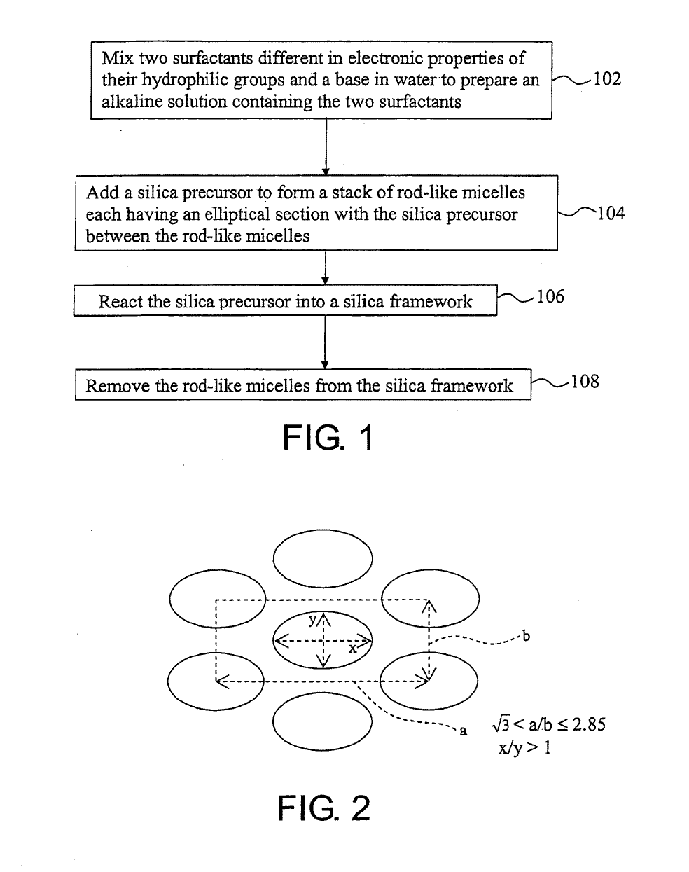

FIG. 1 is a flow chart showing a method of preparing a channel-type mesoporous silica material with c2mm structure according to an embodiment of this invention.

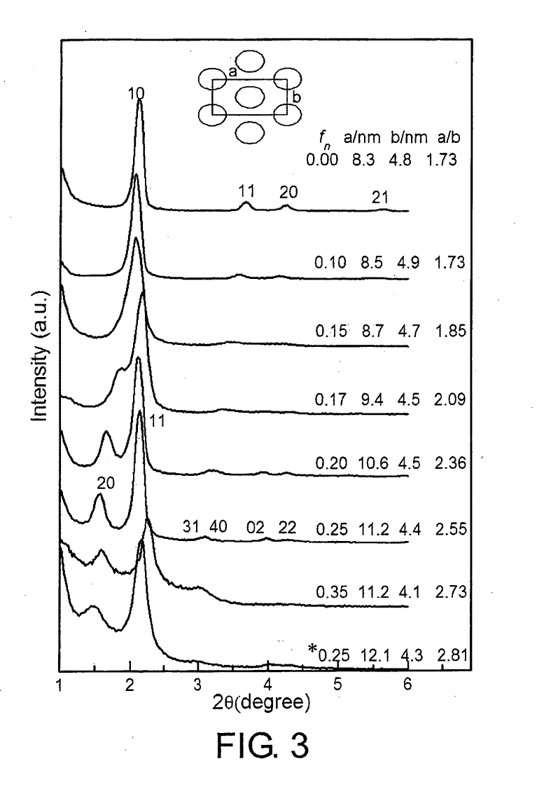

As shown in FIG. 1, two surfactants different in the electronic properties of their hydrophilic groups and a base are mixed in water to prepare an alkaline solution containing the two surfactants (step 102), wherein the base may be added after the two surfactants are added. The two surfactants may include a cationic surfactant and a non-ionic surfactant that can form micelles together. The base may be selected from the group consisting of NaOH, NH₃, KOH, CsOH, LiOH and so forth. Before the preparation step 102, at least one of the combination and the molar ratio of the two surfactants may be selected so as to control the pore shape and the unit cell dimensions of the channel-type mesoporous material obtained. The effects of change in the molar ratio of the two surfactants to the pore shape and the unit cell dimensions can be seen from FIG. 3, as described later in details.

It is possible that the cationic surfactant is a quarternary ammonium salt and the non-ionic surfactant is an alkyleneoxide adduct of a fatty alcohol. For example, the quarternary ammonium is selected from the group consisting of R¹₃R²N⁺, R¹₂R²N⁺—R³—N⁺R²R¹₂ and R¹₂R²N⁺—R³—N⁺R¹₃, and the alkyleneoxide adduct of the fatty alcohol has a formula of R⁴(OA)ₓOH. Each R¹ is independently an alkyl group of C₁-C₃, R² is an alkyl, alkenyl or aryl group of C₁₂-C₂₂, R³ is an alkyl group of C₂-C₅, R⁴ is an alkyl, alkenyl or aryl group of C₁₀-C₁₈, A is an alkylene group of C₂-C₄, and x is within the range of 2-20.

Then, in proper synthesis conditions, which may include a temperature of 15-60° C., a pH value of 9-13 and a total surfactant concentration of 2-50 mM, a silica precursor is added to cause a stack of rod-like micelles to form with the silica precursor between the rod-like micelles (step 104) and trigger the micro-segregation of the surfactant to deform the spherical rod-like micelles to be elliptical micellar rods. The silica precursor may be selected from the group consisting of silicon tetraalkoxides, sodium silicate, silica sol (e.g., Ludox series) and so on. A silica precursor as a silicon tetraalkoxide compound may have a formula of Si(OR)₄, wherein R is an alkyl group of C₁-C₄, such as methyl or ethyl.

In the above synthesis process, it is preferred that when the added amount of the silica precursor is 1-16 molar parts, that of the two surfactants in combination is 0.6-2.0 molar parts, that of the base is 0.15-5.5 molar parts and that of water is 800-20000 molar parts. As for the two surfactants, the molar ratio of the cationic surfactant to the non-ionic surfactant may range from 0.5:0.5 to 0.85:0.15.

Then, the silica precursor is reacted into a silica framework (step 106). As the silica precursor is selected from the above group, the silica precursor can be reacted into the silica framework through hydrolysis and condensation at 15-60° C., which usually continued for 1-24 hours. After the reaction, the synthesis mixture may be aged at 25-100° C. for 1-7 days.

After that, the rod-like micelles are removed from the silica framework (step 108), through thermal calcination or solvent extraction. The thermal calcination may be conducted at a temperature of 300-600° C. The solvent may be an acidified organic solvent like ethanol, methanol or acetone.

FIG. 2 shows a unit cell (enclosed by the dash line) and the unit cell ratio a/b of a channel-type mesoporous silica material with an elliptical pore section according to this invention. The unit cell ratio a/b is greater than \sqrt{3}, and the diameter ratio x/y of each pore is greater than one. In addition, the unit cell ratio a/b is no more than 2.85. This upper limit is reasonably deduced from the experiment result shown in FIG. 3, as explained later. It is noted that in a conventional hexagonal porous structure with a circular pore section, the unit cell a/b is equal to \sqrt{3} and the diameter ratio x/y of each pore is equal to one.

### EXAMPLE

In the example, cetyltrimethyl ammonium bromide (C₁₆H₃₃N(CH₃)₃Br, CTAB) and C₁₂H₂₅(OC₂H₄)₄OH (C₁₂EO₄) were used as the two surfactants different in the electronic properties of their hydrophilic groups, silicon tetraethoxide (tetraethyl orthosilicate, i.e., TEOS) was used as the silica precursor and NaOH was used as a base. At first, 0.91 g of CTAB and 0.3 g of C₁₂EO₄, which corresponds to a molar percentage (fₙ) of 0.25 in the C₁₂EO₄-CTAB mixture, were dissolved in 570 ml of water, and the solution was stirred until all the surfactants dissolved. Thereafter, 21.62 g of 0.4M aqueous NaOH solution was added in the above solution. Then, 5.56 g of TEOS was added in the solution, and the solution was stirred for 2 hours to form white precipitate. After that, the solution was further aged at 90° C. for 2 days. After the white precipitate was separated with filtration and then washed, it was calcined at 540° C. to remove the rod-like micelles.

Additional samples with fₙ-values (molar percentage of C₁₂EO₄ in the C₁₂EO₄-CTAB Mixture) of 0.00, 0.10, 0.15, 0.17, 0.20 and 0.35 respectively were also prepared through the above process flow with the total mole of C₁₂EO₄ and CTAB kept constant, wherein the molar ratio of the reaction composition at a given fₙ-value was 8:fₙ:(1−fₙ):2.56:9840 (TEOS:C₁₂EO₄:CTAB:NaOH:H₂O). It is particularly noted that the sample of fₙ=0.00 is a conventional channel-type mesoporous material with a circular pore section.

FIG. 3 shows the PXRD patterns of the c2mm mesoporous silica materials synthesized in different surfactant ratios in the above example of this invention, which are direct evidences of the formation of such a unique mesoporous structure. It is noted that when fₙ is larger than 0.15, the structure starts to change to c2mm symmetry from p6mm symmetry and five reflections are well resolved to be clearly indexed to the two-dimensional rectangular c2mm plane group. When fₙ is equal to 0.35, the ratio a/b is equal to 2.73. It is apparent from FIG. 3 that the pore shape and the unit cell dimensions of the channel-type mesoporous silica material can be adjusted by changing the molar ratio of the two surfactants.

Moreover, for the last sample with a/b=2.81 (labeled with *) in FIG. 3, the molar ratio of the reaction composition is 8:0.25:0.75:1.95:9840 (fₙ=0.25), and its only difference from the sixth sample of fₙ=0.25 was that the amount of NaOH used in synthesis. Specifically, the amount of 0.4M NaOH solution for preparing the last sample was 16.49 g instead of 21.62 g. It is further expected that an a/b-ratio up to 2.85 can be achieved by fine tuning the synthesis conditions.

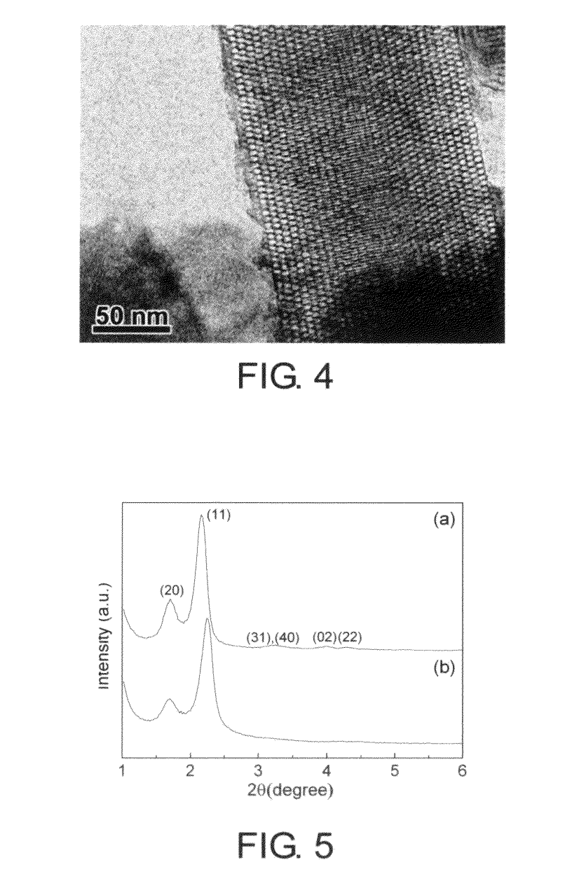

Meanwhile, direct visualization of the elliptical pore section was provided by the transmission electron microscopy (TEM), and the corresponding image of the material is shown in FIG. 4.

Moreover, the elliptical pore section of the materials disclosed in this invention can find potential applications in various advanced field.

For example, functionalized mesoporous silica materials with the same pore structure and c2mm symmetry can be prepared with a modified synthesis process. The modified synthesis is different from the above synthesis of the pure-silica mesoporous material in that a functional silane having the functional group to be included is premixed with the silica precursor. Examples of the functional silane include, but are not limited to, cyanoethyltriethoxysilane, mercaptopropyltriethoxysilane, vinyltriethoxy-silane, allyltrimethoxysilane, phenyltriethoxysilane, octyltriethoxysilane, aminopropyl-triethoxysilane, methacrylpropyltrimethoxysilane, imidazolyltriethoxysilane, chloropropyltriethoxysilane, iodopropyltriethoxysilane and methyltriethoxysilane. Examples of the functionalized mesoporous silica materials include the cyanoethyl-functionalized ones and mercaptopropyl-functionalized ones. The X-ray diffraction patterns of a cyanoethyl-functionalized mesoporous silica material (a) and a mercaptopropyl-functionalized one (b) obtained in another example of this invention are shown in FIG. 5. In this example, the functional silane premixed with TEOS was NCC₂H₄Si(OEt)₃ or HSC₃H₆Si(OEt)₃, and the ratio of the functional silane to TEOS is 0.1:0.9.

Besides, mesoporous silica materials containing one or more heteroatoms in the framework and having the same pore structure and c2mm symmetry can be prepared with another modified synthesis process. The modified synthesis is different from the above synthesis of the pure-silica mesoporous material in that a heteroatom source is premixed with the silica precursor. Examples of the heteroatoms include, but are not limited to, aluminum, titanium, iron, gallium, germanium, zirconium, boron and tin, etc. Examples of the heteroatom source include metal alkoxide and metal salt.

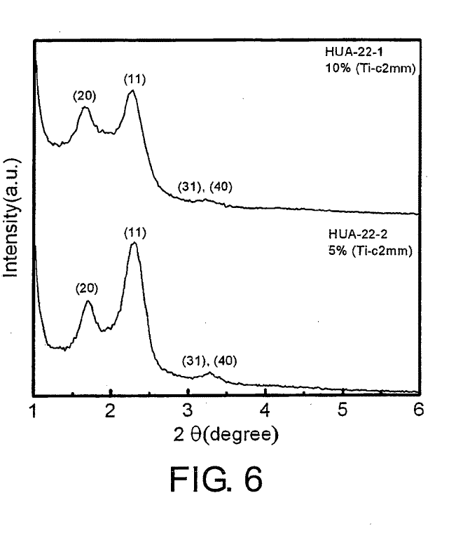

FIG. 6 shows the PXRD patterns of two c2mm mesoporous silica materials containing Ti as a heteroatom obtained in yet another example of the invention, wherein the sample HUA-22-1 contains Ti in a molar percentage of 10% relative to the total of Si and Ti and HUA-22-2 contains Ti in a molar percentage of 5% relative to the same. It is apparent from FIG. 6 that the two mesoporous silica materials containing Ti in the framework still have c2mm symmetry.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A channel-type mesoporous material with an elliptical pore section, the channel-type mesoporous material having a 2D-rectangular pore arrangement, the channel-type mesoporous material comprising silica and having a unit cell ratio a/b satisfying an equality of \sqrt{3}<a/b≦2.85.

2. The channel-type mesoporous material of claim 1, wherein pore surfaces thereof are functionalized.

3. The channel-type mesoporous material of claim 1, wherein a framework thereof contains at least one heteroatom.

4. The channel-type mesoporous material of claim 3, wherein the at least one heteroatom is selected from the group consisting of Ti and Al.
